(19) United States
(12) Patent Application Publication
(10) Pub. No.: US 2026/0050640 A1
(43) Pub. Date: Feb. 19, 2026

(54) SYSTEM

(71) Applicant: SOFTBANK GROUP CORP., Tokyo (JP)

(72) Inventor: Masako SUZUKI, Tokyo (JP)

(73) Assignee: SOFTBANK GROUP CORP., Tokyo (JP)

(21) Appl. No.: 19/299,477

(22) Filed: Aug. 14, 2025

(30) Foreign Application Priority Data
Aug. 16, 2024 (JP) 2024-137231

(51) Int. Cl. G06F 16/951; G06F 16/9536; G06F 16/9538

(52) U.S. Cl. CPC G06F 16/951; G06F 16/9536; G06F 16/9538

(57) ABSTRACT

A system includes a processor that is configured to receive a search keyword from a user, activates a crawling engine to collect information related to the search keyword from information sources on a network, filter the collected information to exclude unreliable information, categorize the filtered information in chronological order and by category, format the categorized information into a portal site format using generative AI, and provide the formatted information to a terminal of the user.

### CROSS-REFERENCE TO RELATED APPLICATION

This application is based on and claims priority under 35 USC 119 from Japanese Patent Application No. 2024-137231 filed on Aug. 16, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, the rapid increase of information on the internet has made it difficult for users to efficiently obtain reliable information relevant to their queries. Especially when searching for information about social or scientific topics, users are often presented with a mixture of trustworthy sources and unverified or false information. This not only leads to information overload but also increases the risk of users being misled by disinformation or unreliable content. There is a need for a system that can automatically collect, filter, and organize relevant information from various sources, and provide the user with reliable and easily accessible content.

### SUMMARY

In order to solve the above problems, the invention provides a system comprising a processor that receives a search keyword from a user, activates a crawling engine to collect information related to the search keyword from various information sources on the network, filters the collected information to exclude unreliable or false data, categorizes the filtered information by chronological order and by category, formats the resulting information in a portal site format using generative AI, and provides the formatted information to the user's terminal. By systematically collecting, filtering, and organizing information, the system enables users to efficiently obtain reliable information in an easily navigable format.

“Processor” means a hardware and/or software component configured to execute programmed instructions and control the operation of the system.

“Search keyword” means a string or group of characters input by a user to specify the subject or topic for which information is to be retrieved.

“Crawling engine” means a program or module designed to automatically traverse and retrieve information from various data sources over a network based on the search keyword.

“Information sources” means various locations on a network, such as websites, news outlets, official organization pages, social networking services, and blogs, from which data can be collected.

“Filtering” means a procedure to assess, screen, and exclude information that is unreliable, false, or of low quality from among the collected data.

“Unreliable information” means data or content from sources that cannot be verified, are anonymous, or have a history of providing incorrect or misleading information.

“Categorizing” means a process of classifying the filtered information according to predefined criteria such as chronological order and content type.

“Chronological order” means the arrangement of information based on the time of publication, discovery, or relevance, usually from newest to oldest.

“Category” means a classification of information based on topic, type, or subject matter, for example, latest news, side effects, or research data.

“Generative AI” means an artificial intelligence module or model capable of generating, organizing, and formatting textual or visual information in response to structured data inputs.

“Portal site format” means a layout or structure of content that presents categorized information in an organized, user-friendly, and easily navigable web page style.

“Terminal” means a user's device, such as a smartphone, computer, or tablet, capable of sending search queries to the server and displaying the received information.

“User” means an individual who interacts with the system by entering search keywords and accessing organized information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

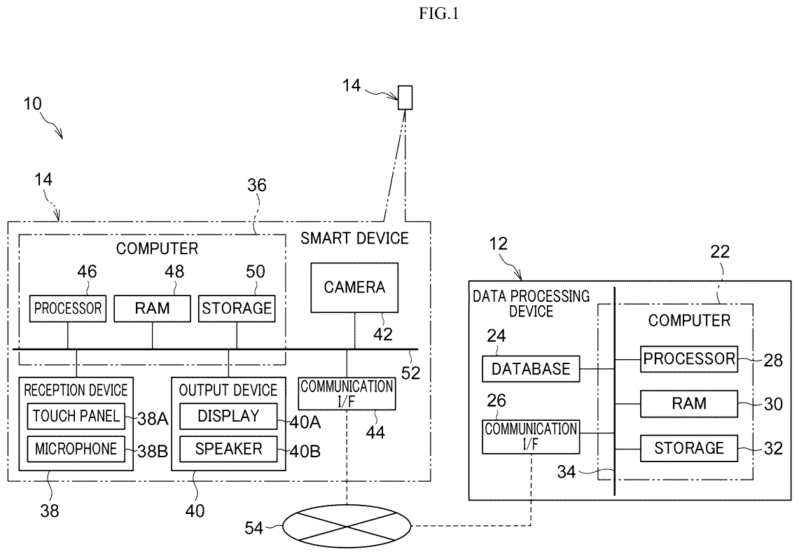

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

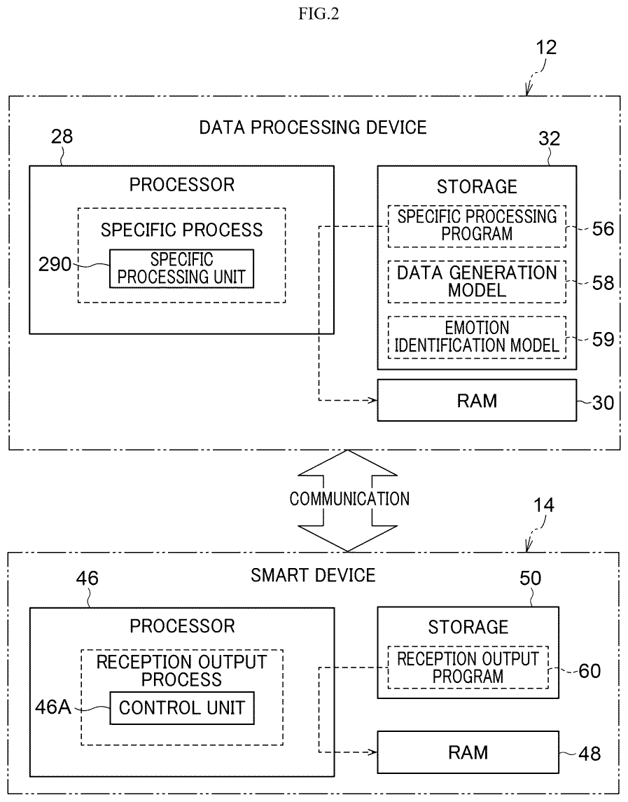

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In recent years, the rapid proliferation of information sources on communication networks has made it increasingly difficult for users to quickly and accurately obtain reliable and relevant information. Conventional information search systems often suffer from the problems of collecting a vast amount of unverified, unreliable, or outdated content, making it challenging for users to distinguish between trustworthy and inaccurate data, especially in situations requiring urgency or high expertise. Additionally, existing systems typically lack the ability to present such refined information in an easily understandable and organized format tailored to the user's needs.

The specific processing by the specific processing unit 290 of the data processing device 12 in Example 1 is realized by the following means.

The present invention provides a server comprising a processor configured to receive search information from a user, automatically acquire related information from multiple information sources over a communication network, process the acquired information by evaluating its credibility and filtering out unreliable content, arrange the selected information chronologically and by category, generate a user-friendly information structure based on a generative intelligence model using an automatically created prompt sentence, and provide the formatted information to a user terminal. This enables users to efficiently obtain highly reliable, well-organized information in response to their search requirements, significantly improving the accuracy and effectiveness of information acquisition.

The term “processor” refers to an information processing unit, such as a central processing unit or microprocessor, which executes instructions to perform operations and control functions within the system.

The term “search information” refers to a query, keyword, or phrase input by a user for the purpose of retrieving related data or content from information sources.

The term “information sources” refers to external or internal databases, servers, websites, or any electronic repositories that provide data, content, or documents accessible over a communication network.

The term “communication network” refers to a system of interconnected components that enables transmission and exchange of data or information between devices, such as the Internet, local area networks, or wireless telecommunications infrastructure.

The term “reliability evaluation” refers to the process of assessing the authenticity, accuracy, and trustworthiness of acquired information based on predetermined criteria or algorithms.

The term “prompt sentence” refers to a command or instruction generated for the purpose of guiding a generative intelligence model in producing a desired output or format.

The term “generative intelligence model” refers to an artificial intelligence engine capable of generating natural language text, structured data, or other formatted content based on input data and a guiding prompt.

The term “information structure” refers to an organized and formatted arrangement of data or content, including categorization and chronological ordering, tailored for enhanced readability and comprehension by a user.

The term “user terminal” refers to any electronic device operated by a user, such as a personal computer, smartphone, tablet, or similar input/output apparatus, which can send requests and receive information from the server.

The term “information providing means” refers to functions or components within the system that output, transmit, or deliver processed and organized information to a user terminal.

An embodiment for implementing the present invention will now be described in detail.

The system comprises a server including a processor, at least one user terminal, a storage unit, a network interface, and other standard computing resources. The server executes software modules that perform receiving, processing, crawling, filtering, classification, generative modeling, and communication procedures as described below. User terminals may be any electronic device equipped with input and display capabilities, for example, a smartphone, a tablet, or a PC.

The server is configured to receive search information, such as keywords or queries, from a user operating a user terminal. The user terminal may comprise a graphical user interface (GUI) implemented in web browser software (such as a standard web browser on Windows, Android, or iOS) that allows the user to input a desired query. The submitted search information is transferred to the server using standardized communication protocols (such as HTTP).

Upon receipt of the search information, the server initiates a crawling operation to acquire related information from various information sources accessible via a communication network. The crawling is performed using software such as Python-based crawling libraries and frameworks, including Scrapy, BeautifulSoup, or similar tools, to extract data from public or authorized web resources. The data collected includes, but is not limited to, text-based publications, databases, news sites, institutional announcements, and relevant online documentation.

The server employs a reliability evaluation algorithm to assess the authenticity and reliability of the gathered information. This algorithm may take into account the source's domain, credibility history, or other metadata to assign a reliability score. For example, official government or academic sources may receive a higher score, while anonymous blogs or unidentified social network posts may be given a lower score. Information falling below a predefined reliability threshold is automatically eliminated, ensuring only trustworthy content is processed further.

Filtered information is then organized in the storage unit, both chronologically and by attribute categories, such as “latest news,” “scientific research,” and “reported adverse reactions.” The server utilizes database management software such as MySQL or PostgreSQL to store, retrieve, and arrange the classified data according to time of publication and content type.

The server then prepares a prompt sentence, which constitutes an instruction set for a generative AI model. The prompt sentence is tailored to reflect both the subject matter of the search information and the current set of chronologically and categorically organized content.

For example, a prompt sentence may read as follows:

Given these chronologically sorted and topically categorized items related to ‘COVID-19 vaccine information’, generate an HTML page with easy-to-understand summaries for each category. The categories should be ‘Latest News’, ‘Reported Side Effects’, and ‘Research Data’. Make the page visually clear and place the newest items at the top of each section.

The generative AI model, such as a large language model (LLM) provided by a commercial or open-source service, is then called via its programming interface (API). The AI model receives the prompt sentence and the relevant data as input, and returns a structured, readable information format such as HTML or simplified structured data.

The server subsequently transmits the formatted information to the user terminal. In the case of HTML, the content is displayed directly in the browser for user reading and interaction; if the data is in a structured format such as JSON, JavaScript code running on the user terminal renders the information into human-readable form.

The user reviews and uses the displayed results for the intended informational purpose, for example, monitoring the latest updates, verifying trustworthy announcements, or reviewing scientific studies. The system minimizes user burden by automating the collection, filtering, organizing, and formatting of information, providing reliable and promptly accessible content in a user-friendly format.

In summary, the invention can be implemented using standard computing hardware, Python-based data crawling tools, relational database software, web browsers as user terminals, and an API-accessible generative AI model. The system is particularly advantageous for rapid aggregation and presentation of reliable information in scenarios where accuracy and timeliness are crucial.

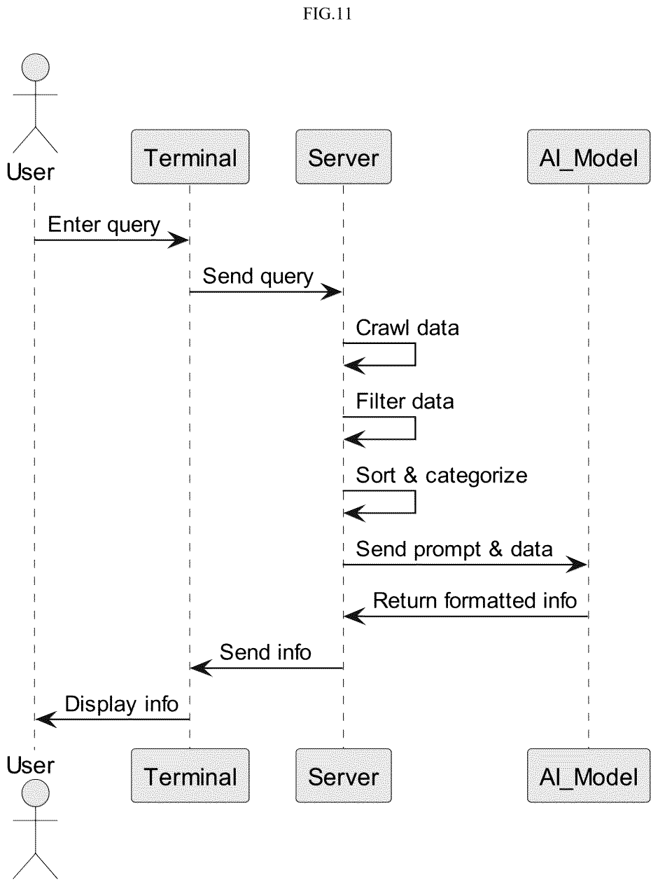

The following describes the processing flow using FIG. 11.

### Step 1:

User enters a search keyword or query, such as “COVID-19 vaccine side effects,” into the search interface provided by the terminal. The terminal displays an input field and search button, capturing the user's input and confirming it before submitting.

Input: User's manual entry of a search keyword.

Output: Search keyword data transmitted to the server.

### Step 2:

Terminal receives the search keyword input from the user and sends it to the server via an HTTP request. The terminal performs URL encoding or proper formatting to package the data and provides visual feedback, such as showing a loading indicator, while waiting for the response.

Input: Search keyword from the user.

Output: HTTP request containing the keyword sent to the server.

### Step 3:

Server receives the HTTP request, parses the contained search keyword, logs the request for monitoring, and sanitizes the keyword for security reasons. The server then prepares the keyword as a parameter for subsequent crawling operation.

Input: HTTP request with the search keyword.

Output: Parsed and sanitized search keyword ready for crawling.

### Step 4:

Server uses a web crawling module, such as Scrapy or BeautifulSoup, to search the internet for documents, articles, or posts relevant to the search keyword. The crawling module constructs appropriate queries and fetches data by sending HTTP requests to target information sources, saving raw HTML and data to a temporary storage area.

Input: Search keyword and crawling parameters.

Output: Collection of raw HTML documents and data from various sources.

### Step 5:

Server stores the collected raw data in a database, such as MySQL or PostgreSQL.

During storage, the server tags each data record with the search keyword, source URL, and retrieval timestamp, organizing data for downstream evaluation.

Input: Raw HTML documents and their metadata.

Output: Database records containing organized raw data.

### Step 6:

Server executes a filtering module to evaluate the reliability of each data record in the database. The server applies algorithms or rule sets that score sources (e.g., government sites as high, unverified blogs as low) and removes data below a predefined trust threshold. The server produces an updated set of information containing only trustworthy items.

Input: Database records of raw information.

Output: Filtered records containing trustworthy and credible information.

### Step 7:

Server retrieves the trustworthy records from the database, sorts them by publication date, and groups them based on content categories such as “Recent News,” “Scientific Studies,” or “Reported Adverse Effects.” The server uses SQL queries to process the data, generating a logically organized set of content.

Input: Filtered trustworthy records.

Output: Chronologically sorted and categorized information sets.

### Step 8:

Server prepares a prompt sentence describing the context, categories, and desired presentation format for the information set. The prompt, along with the categorized content, is sent to a generative AI model through its API. The AI model processes the prompt and content, generating an HTML page or structured data with readable summaries and clear sections.

Input: Sorted and categorized information sets, prompt sentence.

Output: Formatted information structure generated by the AI model.

### Step 9:

Server sends the formatted information, such as HTML or JSON, as an HTTP response to the requesting terminal. The server may perform output validation to ensure content quality and log the transaction for analysis.

Input: Formatted information from the AI model.

Output: HTTP response containing the final information structure delivered to the terminal.

### Step 10:

Terminal receives the formatted information from the server. If the data is HTML, the terminal renders it directly in the browser; if the data is JSON, terminal-side JavaScript dynamically constructs the page for user viewing. The terminal provides a user interface for browsing, sorting, or interacting with the displayed content.

Input: Final formatted information from the server.

Output: Displayed, user-friendly information page on the terminal.

### Step 11:

User browses and utilizes the presented information by reading headlines, summaries, and articles. The user may click on sections for details, bookmark the page, or share links as desired.

Input: Rendered information page on the terminal.

Output: User's actions and decision making based on the acquired information.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional information retrieval systems, there are difficulties in ensuring the reliability of information collected based on user-provided search terms, and in providing such information in a display format optimized for easy utilization by users. Furthermore, especially for wearable devices such as smart glasses, insufficient support for voice input and lack of emotional consideration in information presentation limit the user experience. Existing systems often fail to filter out misinformation adequately, to present information contextually based on the user's emotional state, and to deliver information in an immediately actionable and comprehensible format across visual and audio outputs.

The specific processing by the specific processing unit 290 of the data processing device 12 in Application Example 1 is realized by the following means.

The present invention provides a server comprising a processor configured to receive a search term from a user, collect information related to the search term from multiple information sources via a communication network, perform reliability evaluation and filtering to exclude false information, sort and categorize the filtered information chronologically and by content, utilize a generative artificial intelligence model to optimize information formatting for display, estimate the emotional state of the user based on their input behavior or usage history, adaptively prioritize or adjust displayed content in accordance with the estimated emotion, generate prompt sentences for interaction with the generative artificial intelligence model, perform speech synthesis for audio output, and deliver the information to a user terminal via visual and/or audio interfaces. This enables reliable, contextually appropriate, and multimodal (visual and audio) delivery of information tailored to device characteristics and user emotion, greatly enhancing utility, accessibility, and trust in information retrieval on a wide range of user terminals.

The term “search term” refers to a word or phrase input by a user to indicate the topic or information of interest to be retrieved by the system.

The term “user” refers to an individual who operates a terminal or device to initiate an information search and consume the provided information.

The term “processor” refers to a central processing unit or computational element that executes the instructions of the system, performing data processing, storage, and communication functions.

The term “information source” refers to a digital resource, such as a website, database, or online platform, from which information relevant to the search term can be collected.

The term “communication network” refers to an electronic network, such as the internet, which facilitates the transmission of data between the server, information sources, and user terminals.

The term “information collection engine” refers to a software module or program that automatically gathers information from multiple information sources based on the search term.

The term “information filtering function” refers to a mechanism that evaluates the reliability, authenticity, and relevance of collected data, and removes content identified as false or untrustworthy.

The term “information organizing function” refers to a system process that arranges filtered information in chronological order and categorizes it according to content type or topic.

The term “generative artificial intelligence function” refers to an artificial intelligence model or system that generates, summarizes, or reformats information, optimizing it for human comprehension and device-specific display.

The term “emotion estimation function” refers to an algorithm or process that analyzes user behavior, input, or historical data to infer the emotional state of the user.

The term “information optimization function” refers to a process that adjusts the presentation or prioritization of information according to contextual parameters, including estimated user emotion.

The term “prompt sentence” refers to a structured textual query or instruction generated by the system and sent to the generative artificial intelligence model to elicit a specific information output.

The term “prompt generation function” refers to a process or module that formulates appropriate prompt sentences for input to the generative artificial intelligence model based on the filtered and organized information.

The term “speech synthesis function” refers to a process that converts text-based information into audible speech signals suitable for playback to the user.

The term “visual display device” refers to a hardware component, such as a screen or head-up display, capable of presenting visual information to the user.

The term “audio output device” refers to a hardware component, such as a speaker or headphone, that emits audible signals generated by the system for user perception.

The term “user terminal” refers to any computational device operated by the user, including but not limited to smart glasses, smartphones, tablets, or computers, capable of receiving and presenting information from the system.

The system comprises a server having a processor, and at least one user terminal equipped with a visual display device and/or an audio output device. The user terminal may be a computing device such as a smartphone, tablet, wearable display, or computer. The processor of the server is configured to facilitate reliable and contextually appropriate information retrieval and delivery by means of hardware and software modules that interact through a communication network such as the Internet.

The server receives a search term input from a user via the user terminal. The user provides the search term either through text input using a keyboard or voice input through a microphone integrated in the user terminal. The terminal is equipped with input means (such as a touchscreen keyboard or a voice recognition module based on speech recognition software, for example, an automatic speech recognition API). The search term, along with contextual metadata such as device type and language settings, is transmitted over a secure connection to the server.

The processor activates an information collection engine implemented using software modules (for instance, scripts developed in a programming language such as Python, utilizing HTTP communication libraries and web scraping modules). The information collection engine crawls a plurality of information sources available on the network, including but not limited to websites, online databases, and web services, to gather text data, image data, and metadata associated with the search term.

The server executes an information filtering function that assesses the reliability of each piece of collected data. The filtering may involve rule-based logic, blacklists, or even machine learning models to evaluate the credibility of sources and filter out false, duplicate, or irrelevant information. Additionally, the information is organized chronologically (by timestamp) and classified by content type through a data organizing module, which may employ natural language processing (NLP) algorithms or pattern recognition.

Subsequently, the filtered and organized information is provided to a generative artificial intelligence model, such as a large language model. The server constructs a prompt sentence, for example:
“Summarize and categorize the latest spring outfits trends (grouped by tops, bottoms, and outerwear) for display on a smart glasses HUD. Make the output concise and easy to follow.”
or
“Generate a portal page with sections ‘Latest News’, ‘Vaccine Side Effects’, ‘Scientific Research’ about ‘COVID-19 vaccine information’. If the user appears worried, highlight reassuring facts at the top.”

This prompt instructs the generative AI to format and summarize the data appropriately for the intended device and user context. The response from the generative AI model is parsed by the server and converted into a display format (such as HTML, JSON, or other structured data).

The processor further executes an emotion estimation function, which analyzes user input, search history, and behavior data to estimate the user's emotional state. If the estimated state suggests, for example, anxiety or curiosity, the processor dynamically adjusts the order or style of information display; for example, reassuring content may be presented more prominently for an anxious user. The system optionally optimizes the information not just for content but also for the emotional well-being of the user.

The server transmits the final formatted and optimized information to the user terminal. The terminal employs its visual display device (such as a screen or HUD in smart glasses) to present the result in a user-readable layout. If equipped, the terminal uses an audio output device (e.g., speaker or headphones) along with text-to-speech software (such as a speech synthesis library) to read out the information, enhancing accessibility for visually impaired users or in hands-free scenarios.

For example, if a user wearing smart glasses says, “Show me the latest spring outfits,” the system processes the request by performing information collection, trustworthiness filtering, categorization (such as tops, bottoms, outerwear), and formatting using a generative AI model. The processed result is displayed as categorized items on the smart glasses display and may be read aloud by the terminal's speaker.

In this way, the invention may be implemented using widely available hardware (general purpose computers, smartphones, smart glasses, microphones, displays, speakers) and software such as a web server application, web scraping libraries, natural language processing engines, large language models, and speech synthesis modules. The inventive system enables real-time delivery of reliable, emotionally optimized, and multimodal information tailored to user, device, and context.

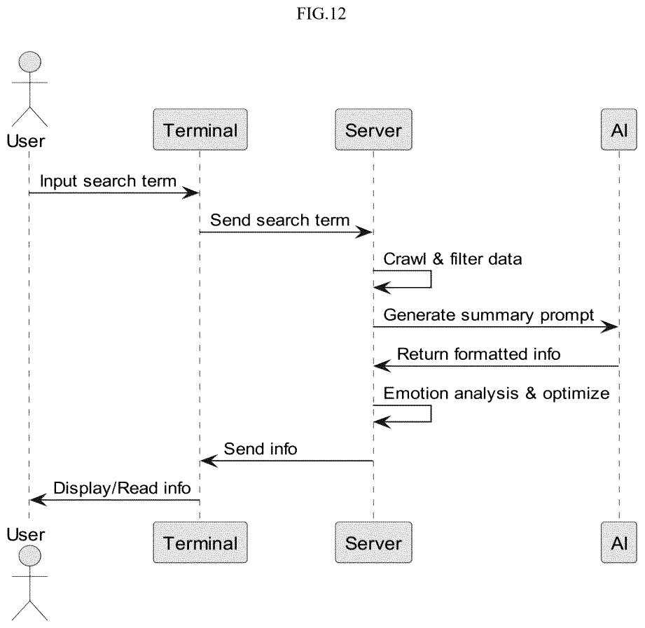

The following describes the processing flow using FIG. 12.

### Step 1:

User enters a search term using the terminal, either by typing on a keyboard or speaking into a microphone.

Input: User's manual text entry or voice input.

Action: The terminal detects the input method, converts voice input to text via speech recognition software if applicable, and prepares the keyword data.

Output: Text-based search keyword with any device and language settings attached.

### Step 2:

Terminal sends the search keyword and contextual metadata to the server over a secure network connection.

Input: Search keyword, device type, and optional language or region metadata.

Action: The terminal creates a data packet and transmits it to the server's designated API endpoint using a communication protocol (e.g., HTTPS).

Output: Server receives a formatted request containing the keyword and metadata.

### Step 3:

Server receives the search request from the terminal.

Input: Data packet containing search keyword and metadata.

Action: The server parses the incoming request, logs the search action, and extracts parameters for subsequent processing.

Output: Parsed search keyword and metadata available for internal processing.

### Step 4:

Server initiates the information collection engine to retrieve data from multiple information sources relevant to the search keyword.

Input: Parsed search keyword and user context.

Action: The server activates crawling software, accesses predefined sources such as websites and online databases, and extracts relevant information such as text snippets, images, and timestamps.

Output: Raw, unfiltered data set related to the search term.

### Step 5:

Server filters the collected information to remove content deemed unreliable or irrelevant.

Input: Raw data set from information collection engine.

Action: The server applies filtering logic (e.g., source credibility checks, blacklist matching, machine learning classifiers) to identify and exclude false, duplicated, or low-trust data items.

Output: Filtered, reliable information set.

### Step 6:

Server organizes and categorizes the filtered information chronologically and by content type.

Input: Filtered, reliable information set.

Action: The server sorts data by timestamp and applies content analysis methods to assign each data item to a relevant category (e.g., using NLP or rule-based classifiers).

Output: Structured data set with categorized and time-ordered information.

### Step 7:

Server generates a prompt sentence for the generative AI model based on the organized data and device characteristics.

Input: Structured data set, user context, and device type.

Action: The server composes a prompt that instructs the generative AI model on the required summary, categorization, and output style (e.g., “Summarize and categorize the latest trends for display on smart glasses”).

Output: Prompt sentence for submission to the generative AI model.

### Step 8:

Server sends the prompt and organized information to the generative AI model and receives the formatted output.

Input: Prompt sentence and structured data set.

Action: The server interacts with the generative AI model's API, submitting the prompt and data, and receives a summarized and reformatted output suitable for display and/or audio.

Output: Formatted information optimized for terminal display or audio output.

### Step 9:

Server estimates the emotional state of the user based on search behavior or historical data.

Input: User's search keyword, behavior data, and access history.

Action: The server processes the input with an emotion estimation function such as an NLP-based emotion recognition algorithm to infer user emotion.

Output: Estimated emotional state (e.g., anxious, interested, neutral).

### Step 10:

Server adjusts the content or display order according to the estimated user emotional state.

Input: Formatted information and estimated emotional state.

Action: The server applies information optimization logic to highlight, reorder, or annotate content (for example, bringing reassuring items to the top if the user is anxious).

Output: Emotion-optimized information package for user terminal.

### Step 11:

Server sends the final formatted and optimized information to the user terminal as a data package (e.g., HTML, JSON).

Input: Emotion-optimized information package.

Action: The server transmits the data package via a secure communication protocol to the user terminal.

Output: Data package received by the terminal.

### Step 12:

Terminal presents the received information visually and/or by audio output to the user.

Input: Data package with display- and audio-ready content.

Action: The terminal parses the package to display the categorized information using the display device and, if equipped, converts text to speech using speech synthesis software to present through the audio output device.

Output: Information displayed on the terminal and/or audibly presented to the user.

### Step 13:

User consumes and optionally interacts with the information via the terminal interface.

Input: Visual and/or audio presentation on the terminal.

Action: The user reviews the information, navigates categories, and may select content for further interaction or request more details as needed.

Output: User actions or feedback, which can be captured for further processing or personalization.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In the current information environment, users face significant challenges in efficiently and rapidly obtaining reliable information from vast and diverse sources available via communication networks. Furthermore, there is a risk that users may be misled by low-reliability or false information, such as rumors or misinformation, which can negatively influence their actions or decisions. Conventional information gathering systems do not adequately consider the emotional state of users when prioritizing information, resulting in users often being unable to quickly access the most appropriate information according to their personal context or emotional needs.

The specific processing by the specific processing unit 290 of the data processing device 12 in Example 2 is realized by the following means.

The present invention provides a server comprising a processor configured to receive information search terms from a user, collect relevant information from information sources on a communication network, evaluate and filter out low reliability or false information, organize the remaining information by time and category, structure the organized information into a display format using automated information generation technology, transmit the display data to a user terminal, and dynamically adjust information output priority based on the user's emotional state estimated from search terms and operation history. This enables users to quickly and efficiently access highly reliable information, where the display priority is dynamically adjusted to address individual emotional contexts, thereby improving both the usefulness and trustworthiness of the information provided.

The term “processor” refers to a device or component that executes instructions and performs data processing tasks as defined by program code.

The term “information search term” refers to a keyword or phrase input by a user to request specific information from the system.

The term “communication network” refers to an interconnected system, such as the Internet or an intranet, that allows for the exchange of data and information between devices.

The term “information sources” refers to various repositories or locations accessible through a communication network, including websites, databases, or other data storage entities, from which information can be collected.

The term “information collection process” refers to a series of operations performed by the processor to obtain information from information sources based on the information search term.

The term “reliability evaluation” refers to the assessment of the trustworthiness or credibility of collected information, considering factors such as source authority, consistency, and authenticity.

The term “information selection process” refers to the exclusion or filtering of collected information that is determined to be of low reliability or false content.

The term “information organization process” refers to the procedure by which selected information is sorted or categorized, such as by chronological order and relevant classification criteria.

The term “automated information generation technology” refers to a technology, including generative artificial intelligence models, that produces structured or summarized output data based on organized information for display purposes.

The term “output data” refers to the structured and formatted information, ready for presentation and transmission to a user terminal.

The term “terminal device” refers to a user's computing device, such as a personal computer, smartphone, or tablet, that receives and displays output data.

The term “emotional state” refers to the psychological mood or sentiment of the user, as estimated or inferred from search terms and operation history.

The term “information prioritization adjustment process” refers to the dynamic modification of display order or emphasis of output data based on the user's estimated emotional state.

The term “input-output device” refers to a component that facilitates user data entry (such as search terms) and enables communication between the user and the system.

An embodiment for implementing the invention will now be described in detail. The system consists of a server, a terminal device (client), and a user. The server includes a processor, data storage, and is operably connected to a communication network, such as the Internet. The terminal device can be any computing device, such as a personal computer, tablet, or smartphone, with display and input capabilities that allow a user to interact with the system.

The server executes a program that performs the functions described in the claims. The server receives an information search term entered by the user through the terminal device. The terminal device presents an input field (for example, a search box on a web browser or a mobile application) that allows the user to enter the desired information search term. The user inputs a keyword or phrase, such as “COVID-19 vaccine information.”

The terminal transmits the search term to the server through the communication network using standard transfer protocols (e.g., HTTP or HTTPS).

Upon receiving the search term, the server collects information relevant to the keyword from a variety of information sources on the network. Information sources may include web pages, databases, online news sites, scientific repositories, and official institutional websites. The server collects this information automatically using a crawling engine, such as a commonly available open-source software like a general-purpose web crawling framework or a network scraping tool.

After data collection, the server evaluates the reliability of the gathered data. The evaluation may use multiple criteria, including the source's authority, the presence of consistent data across multiple sites, and reputation metrics. Low-reliability and false information, such as unverified rumors, is excluded using a filtering software module. Filtering may employ machine learning models, scoring mechanisms, or fixed rule-based algorithms.

Selected data that passes the reliability filter is then organized by the server. The organization process includes sorting the information chronologically based on its date of publication, and classifying it into categories such as news updates, research data, or health guidelines. The organization is achieved using a database system and categorization algorithms. Text analysis libraries can be used for semantic classification.

Next, the server formats the organized data for display output using automated information generation technology. Specifically, a generative artificial intelligence model, such as a large language model, receives a prompt sentence and the organized data as input. The generative AI model outputs human-readable summaries, headlines, or structured presentations. Prompt sentence examples that may be used include:

“Summarize the latest scientifically verified COVID-19 vaccine information in sections: Latest News, Side Effects, and Research Data. Emphasize reassuring statistics if the user is anxious.”

The server further estimates the user's emotional state based on the search term and, if available, user operation history. Sentiment or emotion detection is executed using natural language processing software, for example, a transformer-based model trained to detect sentiment. If the user is determined to be anxious, worried, or in need of reassurance, the server dynamically changes the display priority to present more comforting and authoritative information at the top of the output.

Finally, the server transmits the display-formatted data to the terminal device, which receives and displays the data in a user-friendly, categorized portal site style. The terminal device uses its rendering engine, such as the browser or a mobile app UI, to present the organized information to the user. The user reviews the information, can access detailed content by following display links, and may perform additional searches or interactions as required.

This embodiment uses general-purpose hardware for the server and the terminal device, and may employ software modules such as natural language processing libraries, web crawling frameworks, machine learning libraries, and generative AI models for core processing. This configuration enables users to quickly access highly reliable, appropriately prioritized information, with the presentation adapting to the user's emotional state.

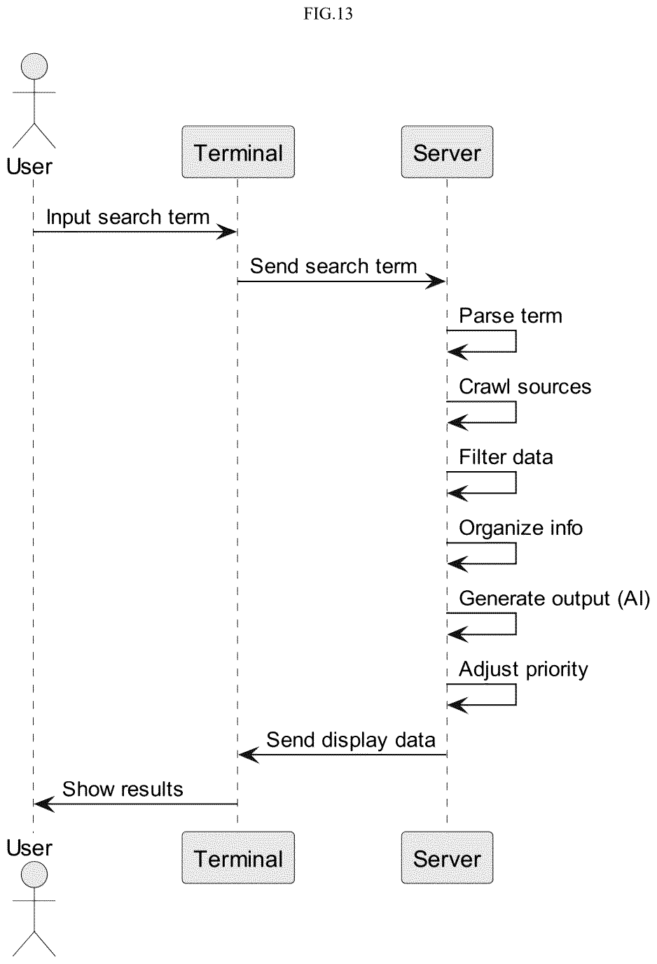

The following describes the processing flow using FIG. 13.

### Step 1:

The terminal displays a search input interface to the user.

Input: Booted application or web page on the terminal.

Output: A visible input field is shown, allowing the user to enter a search keyword.

The terminal generates and renders the UI element for receiving an information search term from the user.

### Step 2:

The user enters an information search term and initiates a search request.

Input: Search input field presented on the terminal display.

Output: An information search term, such as “COVID-19 vaccine information,” entered and confirmed by the user.

The user types the desired query using the on-screen keyboard and triggers the submission.

### Step 3:

The terminal transmits the search request to the server over the communication network.

Input: The information search term provided by the user.

Output: A transmission of the search request, typically using a POST HTTP request containing the search term as a parameter, sent to the server's endpoint.

The terminal packages the data and securely transmits it via network protocols.

### Step 4:

The server receives the search request and parses the search term.

Input: HTTP request containing the user's search term.

Output: Parsed form of the search keyword, identifying key concepts and extracting relevant segments.

The server uses a text analysis library or keyword extraction module to process the search term and store parsed results for downstream processing.

### Step 5:

The server collects relevant information from various information sources on the network.

Input: Parsed search keyword and associated information.

Output: A dataset containing raw information related to the search keyword collected from multiple network sources, such as web pages or news sites.

The server initiates a crawling engine or web scraping tool, sends requests to predetermined information sources, and aggregates content relevant to the search term.

### Step 6:

The server filters and evaluates the reliability of the collected information.

Input: Dataset with raw, unfiltered information.

Output: Filtered dataset containing only information evaluated as reliable and excluding low-credibility or false items.

The server applies reliability scoring algorithms or rule-based filters, discarding untrustworthy or duplicate data, and retaining only authoritative information for further processing.

### Step 7:

The server organizes the filtered information chronologically and by category.

Input: Filtered, reliable information dataset.

Output: Organized dataset, where information is sorted by publication date and classified into categories, such as “Latest News,” “Research Data,” or “Side Effects.”

The server processes metadata, analyzes content with a classification algorithm, and stores categorized results in a structured data repository.

### Step 8:

The server generates display-formatted output using a generative AI model.

Input: Organized, categorized dataset, and a prompt sentence designed to guide content generation (for example, “Summarize the latest scientifically verified COVID-19 vaccine information in sections: Latest News, Side Effects, and Research Data. Emphasize reassuring statistics if the user is anxious.”).

Output: Human-readable summaries and structured text content suitable for display in a portal format.

The server sends the organized information and prompt to the generative AI model, then receives and stores the generated output for subsequent steps.

### Step 9:

The server estimates the user's emotional state and adjusts the display priority of generated information.

Input: Search term and, optionally, user operation history; generated content from the previous step.

Output: Priority-adjusted output data where information arrangement (such as emphasis or order) is modified based on the user's detected emotional state.

The server applies an emotion recognition model to infer user sentiment and changes the presentation of information, giving priority to content matched to the user's emotional context (e.g., showing reassuring statistics for anxious users).

### Step 10:

The server transmits the final display data to the terminal device.

Input: Priority-adjusted output data.

Output: A formatted data package (in HTML, JSON, or other suitable form) sent over the network to the terminal.

The server serializes the content for transmission and initiates a response using communication protocols.

### Step 11:

The terminal receives and renders the display-formatted information to the user.

Input: Formatted output data received from the server.

Output: Categorized and contextually prioritized information displayed on the terminal; a portal page or application screen with summaries, headlines, categories, and selectable links.

The terminal parses the data and uses its rendering engine to layout and present the information interactively to the user.

### Step 12:

The user reviews the displayed information and may further interact with the portal. Input: Categorized, accessibility-enhanced information presented on the terminal interface.

Output: User navigation, content selection, or additional search requests based on interest or need.

The user browses sections, clicks on links for more details, and can repeat search queries as desired.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In the current information society, users are confronted with an overwhelming amount of information from various sources on the internet, within which unreliable data and misinformation are frequently present. Users often experience difficulty in efficiently obtaining reliable and relevant information, especially information that is tailored to their individual interests and psychological states. Additionally, conventional information retrieval systems do not adequately prioritize the presentation of information according to users' emotional conditions, which can result in increased stress, confusion, or anxiety for users during information searching and decision making.

The specific processing by the specific processing unit 290 of the data processing device 12 in Application Example 2 is realized by the following means.

The present invention provides a server comprising a processor configured to obtain character string information from a user, collect related information from a plurality of sources via a communication network, evaluate the reliability of collected information and remove erroneous data, organize the evaluated information temporally and by attribute, generate an integrated information display using a generative information processing unit, analyze user interaction or usage history to estimate emotional state, and control the order of displayed information according to the estimated emotional state. This enables the user to efficiently and stresslessly acquire trustworthy information suited to their informational needs and emotional situation, thereby facilitating more appropriate and comfortable information retrieval and decision making.

The term “character string information” refers to a set of one or more words, phrases, or keywords entered by a user for the purpose of searching or retrieving information.

The term “information source” refers to any accessible origin of data or content available via a communication network, including but not limited to websites, databases, online publications, social media services, and digital repositories.

The term “communication network” refers to an infrastructure enabling data exchange between devices or systems, such as the Internet or other data transmission networks.

The term “reliability evaluation” refers to the process of assessing the trust worthiness, accuracy, and validity of collected information based on predetermined criteria or algorithms.

The term “erroneous information” refers to any data deemed false, misleading, inaccurate, or lacking in credibility according to the reliability evaluation.

The term “attribute type” refers to a classification parameter by which information is organized, such as category, topic, subject, or other distinguishing characteristics.

The term “integrated information display format” refers to a structured output or presentation layout that combines and organizes information from multiple sources in a manner optimized for user understanding and usability.

The term “generative information processing unit” refers to a functional component or software module that uses artificial intelligence or machine learning techniques to synthesize, create, and layout integrated information based on input data.

The term “user interaction history” refers to a record of a user's previous activities, inputs, or behavioral patterns while utilizing the system.

The term “emotional state” refers to a psychological condition or affective status estimated for the user, such as anxiety, confidence, curiosity, or calmness, based on analysis of user data.

The term “user terminal device” refers to a computing device operated by the user, such as a mobile phone, tablet, or personal computer, which enables information input, reception, and display.

One embodiment for implementing the present invention will be described below, based on the claims of the invention.

The system comprises a server including a processor and a user terminal device such as a smartphone, tablet, or personal computer. The server operates in communication with the user terminal via a communication network, for example, the Internet.

The server is equipped with various software modules. For example, a web crawling engine (such as Scrapy or an equivalent program), filtering algorithms (which may utilize conventional programming languages such as Python, together with reputation evaluation APIs), machine learning-based classification modules (examples include scikit-learn or spaCy), a generative artificial intelligence model (such as a large language model like GPT-4 or an equivalent), and an emotion recognition model (which may be a fine-tuned neural network, such as a BERT-based model or another suitable machine learning model).

When a user wishes to search for information, the user operates the user terminal device to enter a query in the form of character string information, for example, by typing a search keyword in an application or web browser interface. The terminal sends the query through the network to the server.

Upon receiving the query, the server uses the web crawling engine to automatically collect information relevant to the received keyword from various information sources such as websites, online repositories, social media content, and official publications. The collected raw information is temporarily stored in a database (such as PostgreSQL or MongoDB).

The server then executes the evaluation of reliability for each collected information item, for instance by checking source credibility, author reputation, recency, and other predefined filtering criteria. This process filters out erroneous or misleading data, retaining only information assessed as reliable.

Next, the server classifies the filtered information by attribute type and arranges the information according to time of occurrence or relevance, using a classification system based on machine learning algorithms.

The generative information processing unit then receives the classified information and synthesizes it into an integrated information display format. For example, the generative AI model creates a web portal page summarizing and organizing the information for optimal user comprehension, automatically structuring sections by importance, attribute, and chronology.

Meanwhile, the server analyzes the user interaction history or usage records stored in the server to estimate an emotional state of the user, using an emotion recognition model. For example, if a user has previously searched for questions like “Is vaccine safe?” or has interacted mostly with information tagged as high risk, the server may estimate that the user's emotional state is anxious.

Based on the estimated emotional state, the server's processor prioritizes and controls the order of the information transmitted to the user terminal. If the user is detected as anxious, for example, the server can present reliable, reassuring official announcements or positive news items at the top of the display, while more neutral or technical information is shown in lower sections.

The server converts the integrated and prioritized information (typically to HTML or JSON) and transmits it to the user terminal device. The terminal receives and displays this information in a portal format, allowing the user to conveniently browse the content, access categorized sections, and quickly obtain trustworthy information relevant to their needs and their mental state.

A concrete example is as follows. Suppose the user enters “COVID-19 vaccine information” as a search query. The server collects and filters a large amount of related web content, classifies the information into categories such as “Latest News,” “Research Data,” and “User Reviews,” and recognizes from the user's history that the user tends to be anxious about health matters. The generative artificial intelligence model prepares a portal web page display where the most reassuring and official content about the vaccine appears first, followed by technical research and then user experiences further down the page.

An example of a prompt sentence for the generative AI model, as used in this embodiment, would be as follows:

Please provide reliable, up-to-date information for the keyword “COVID-19 vaccine information.” Classify items as “Latest News,” “Research Data,” and “User Reviews.” Highlight reassuring content suitable for an anxious user at the top of the page.

Through these components and processes, the system enables users to efficiently and comfortably access reliable, appropriately prioritized information tailored to their personal interests and psychological conditions.

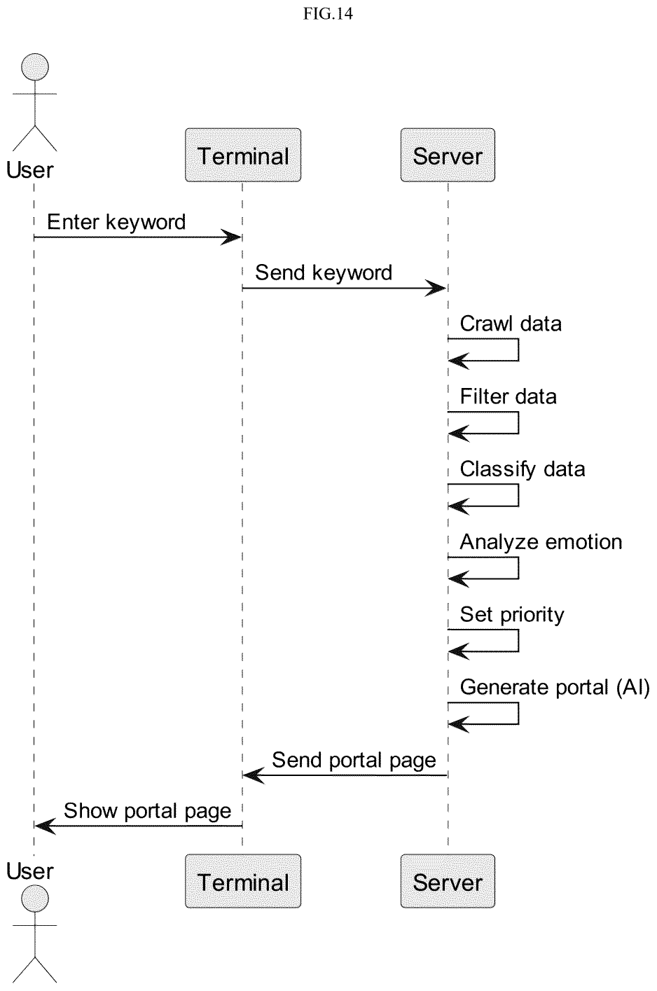

The following describes the processing flow using FIG. 14.

### Step 1:

User operates the terminal device to access the system's search interface and enters a character string as a search keyword. The terminal receives the user's input and displays a confirmation button. When the user confirms, the terminal transmits the entered keyword to the server via the communication network as a search query. The input is a text string from the user; the output is a structured query sent to the server.

### Step 2:

Server receives the search query from the terminal. The server triggers the web crawling engine with the received keyword as the search parameter. The server then initiates API calls, HTTP requests, or web scraping routines to collect articles, posts, and documents from multiple information sources, including official websites, databases, social networks, and online publications. The input is the search query; the output is a collection of raw data entries matching the keyword.

### Step 3:

Server processes the raw data using the filtering system. The filtering program evaluates the credibility and accuracy of each collected information item by checking metadata such as publication date, source domain, and content consistency. The server excludes erroneous, outdated, or unreliable information based on the filtering criteria. The input is the raw collection of content; the output is a filtered dataset retaining only trustworthy items.

### Step 4:

Server categorizes and organizes the filtered information. The server uses a classification module built on machine learning algorithms to assign each piece of information to an attribute type such as “Latest News,” “User Review,” or “Research Data.” The server sorts these entries by occurrence date and stores attribute and time metadata. The input is the filtered dataset; the output is an organized data set with labels and sort order.

### Step 5:

Server analyses user interaction history, such as past search queries or click records, using the emotion recognition module. The server runs a machine learning model to estimate the user's emotional state, such as anxious or calm. The input is the user's interaction log; the output is a classification indicating the estimated emotional status of the user.

### Step 6:

Server sets the display priority for the information set. The server's logic adjusts the order and prominence of information according to the estimated emotion. For example, if the emotion is anxious, the server increases the priority for official, reassuring sources. The input is the emotional status and organized data; the output is a priority-sorted information list.

### Step 7:

Server prepares a prompt sentence for the generative AI model, such as: “Provide reliable, up-to-date information for the keyword ‘COVID-19 vaccine information.’ Classify as ‘Latest News,’ ‘Research Data,’ and ‘User Reviews.’ Highlight content that can reassure an anxious user.” The server transmits the sorted, labeled information and the prompt to the generative AI model. The input is the priority list and prompt sentence; the output is a structured, integrated portal layout tailored for the user.

### Step 8:

Server transforms the generated integrated portal page into a suitable data format, such as HTML, CSS, or JSON. The server transmits this formatted portal page to the terminal device. The input is the AI-generated portal content; the output is responsive interface data sent to the terminal.

### Step 9:

Terminal receives the portal content and renders the integrated information display for the user. The terminal allows the user to browse, select categories, expand details, or perform actions such as bookmarking or sharing information. The input is the portal page data; the output is the visual, interactive portal page presented to the user.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

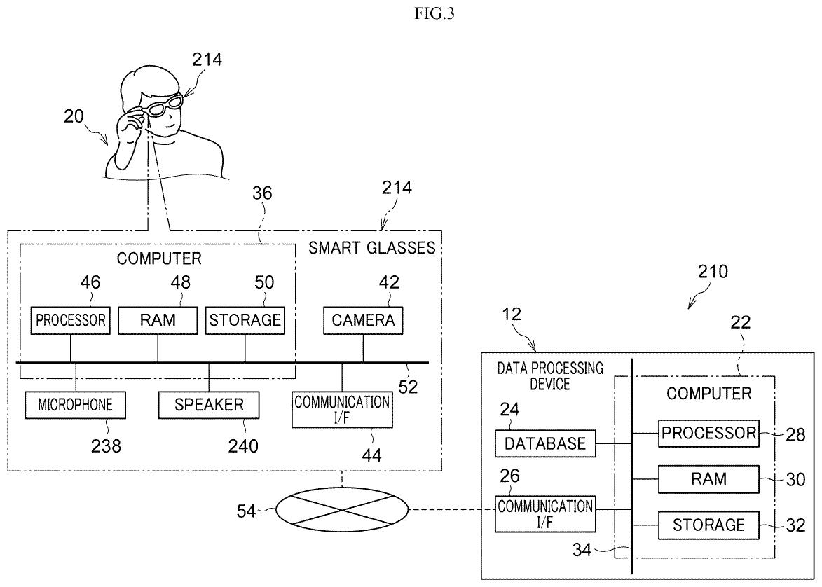

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

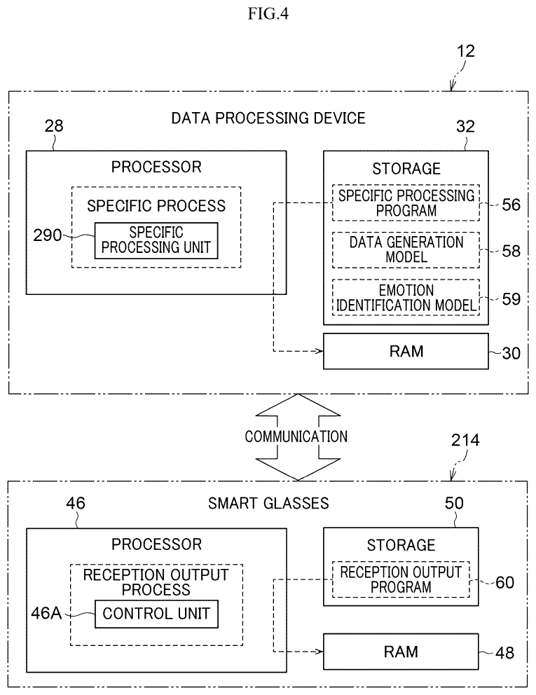

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

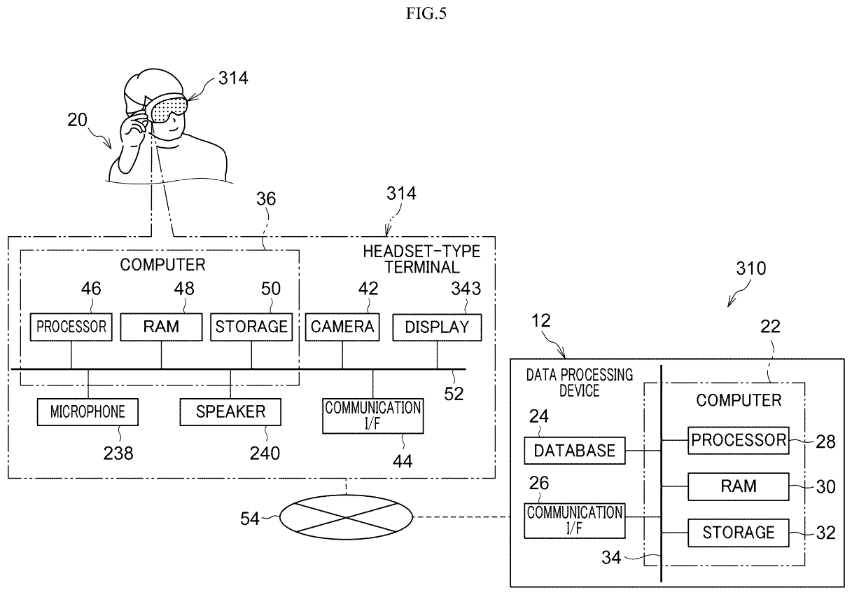

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

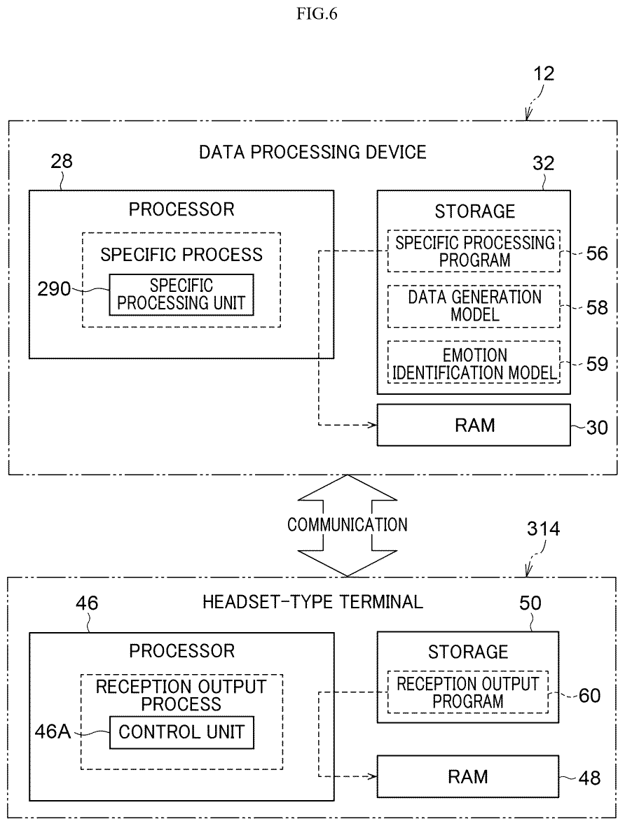

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

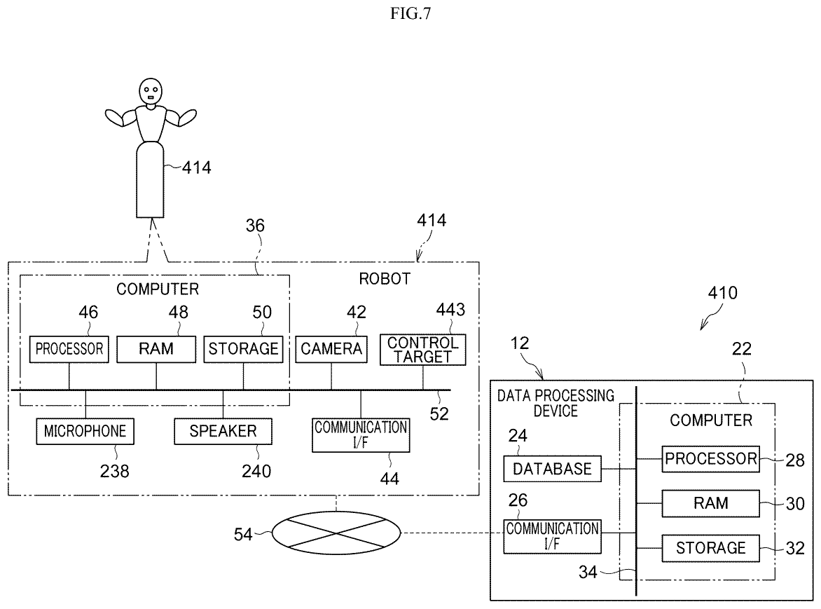

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

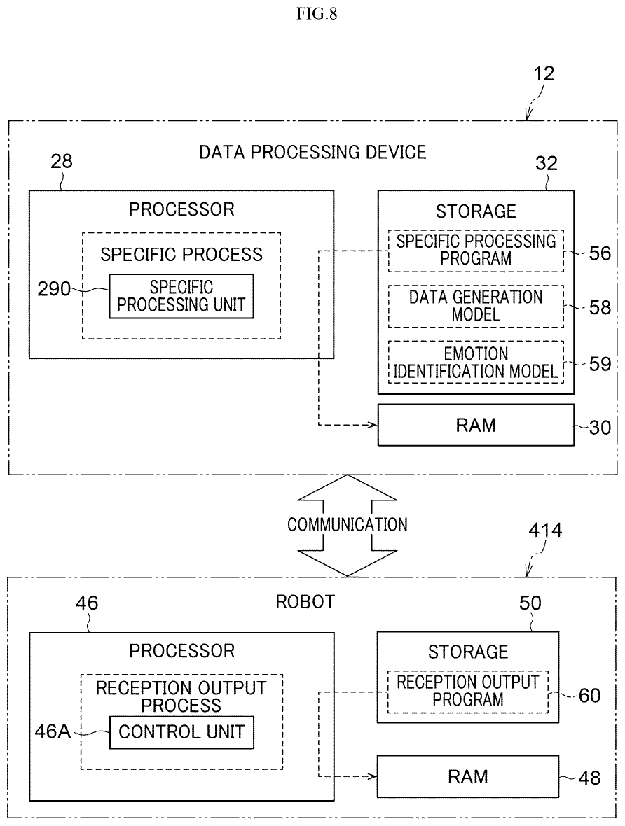

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

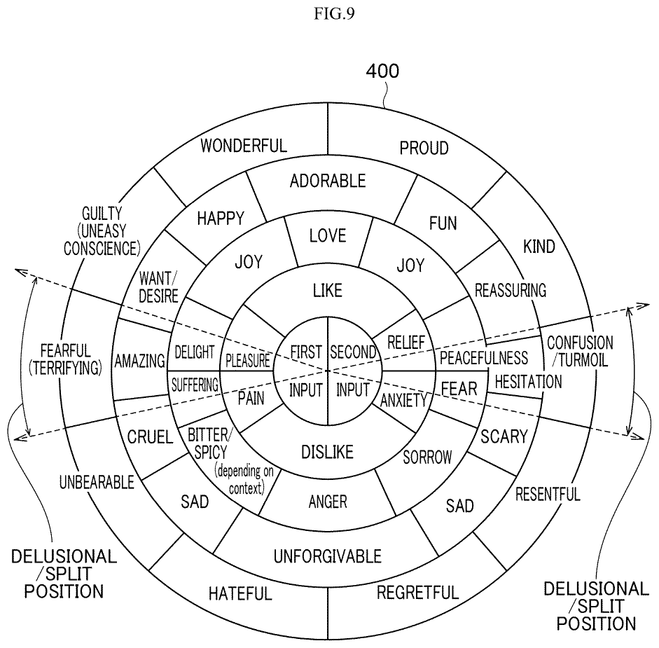

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

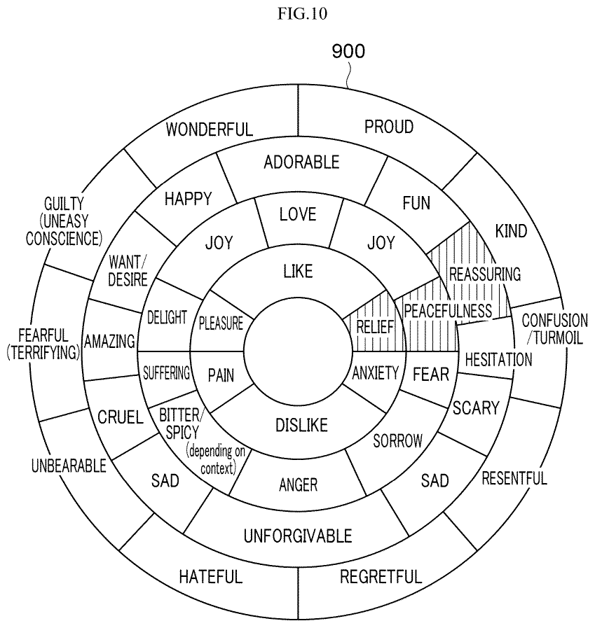

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive search information from a user,
automatically acquire related information regarding the search information from information sources over a communication network,
evaluate the reliability of the acquired related information, determine the authenticity of the information, and remove inaccurate or unreliable information,
order the selected information in chronological order and classified by attributes,
generate, using a generative intelligence model, a human-understandable information structure that reflects the categories and occurrence time of the related information, by formatting the ordered information into a display format which is easy for the user to view,
provide the generated information structure to a user terminal via a communication means, and
generate a prompt sentence for instructing the generative intelligence model to perform the automatic information structuring process using the ordered information as input.

### (Supplementary 2)

The system according to supplementary 1,
wherein the processor is configured to
receive and display the information structure, ordered by the information arranging means and formed by the generative intelligence model.

### (Supplementary 3)

The system according to supplementary 1,
wherein the processor is configured to
permit the input of the search information and the transmission thereof to the information providing means by an information terminal control means.

### Application Example 1

### (Supplementary 1)

A system comprising a processor,
wherein the processor is configured to
receive a search term from a user;
collect information related to the search term from a plurality of information sources via a communication network using an information collection engine;
evaluate the reliability of the collected information and remove false information using an information filtering function;
sort the filtered information in chronological order and categorize the information by content using an information organizing function;
format the organized information into a display format optimized for a display device by using a generative artificial intelligence function;
estimate an emotional state of the user based on user input behavior or past usage history using an emotion estimation function;
adjust the display content or display order of the information according to the estimated emotional state using an information optimization function;
generate a prompt sentence for a generative artificial intelligence model using a prompt generation function;
convert the formatted information into audio by using a speech synthesis function; and
deliver the formatted information to a user terminal via a visual display device or an audio output device.

### (Supplementary 2)

The system according to supplementary 1,
wherein the processor is configured to
receive the filtered and organized information and present the information to the user via a visual display device or an audio output device.

### (Supplementary 3)

The system according to supplementary 1,
wherein the processor is configured to
include an input device and a transmission device for the input and transmission of the search term.

### Example 2

### (Supplementary 1)

A system comprising a processor,
wherein the processor is configured to
receive an information search term from a user,
collect information related to the information search term from information sources on a communication network by executing an information collection process,
evaluate the reliability of the collected information and exclude low reliability information and false information by executing an information selection process,
organize the selected information based on chronological order and classification criteria by executing an information organization process,
generate output data by structuring the organized information into a display format using an automated information generation technology,
transmit the output data to a terminal device of the user, and
estimate the user's emotional state from the search term and operation history of the user, and dynamically adjust the output priority of the information according to the emotional state by executing an information prioritization adjustment process.

### (Supplementary 2)

The system according to supplementary 1,
wherein the processor is configured to
provide, to a display device, the selected information and information for which the output priority has been adjusted by the information prioritization adjustment process, in a display format.

### (Supplementary 3)

The system according to supplementary 1,
wherein the processor is configured to
perform input and transmission processing of the information search term using an input-output device.

### Application Example 2

### (Supplementary 1)

A system comprising a processor,
wherein the processor is configured to
obtain character string information from a user, automatically collect information related to the character string information from a plurality of information sources via a communication network,
evaluate the reliability of the collected information and remove erroneous information,
organize the evaluated information in order of occurrence time and by attribute type, generate an integrated information display format and automatically design a presentation
structure for the organized information using a generative information processing unit,
transmit the integrated information display format to an information processing device of the user,
analyze user interaction history or usage history to estimate an emotional state of the user, and
control the order of displayed information based on the estimated emotional state.

### (Supplementary 2)

The system according to supplementary 1,
wherein the processor is configured to
display prioritized information in said integrated information display format in accordance with the estimated emotional state.

### (Supplementary 3)

The system according to supplementary 1,
wherein the processor is configured to
cause a user terminal device to input and transmit the character string information.

What is claimed is:

1. A system comprising a processor,
wherein the processor is configured to:
receive a search keyword from a user;
activate a crawling engine to collect information related to the search keyword from information sources on a network;
filter the collected information to exclude unreliable information;
categorize the filtered information in chronological order and by category;
format the categorized information into a portal site format using generative AI; and
provide the formatted information to a terminal of the user.

2. The system according to claim 1, wherein the processor is configured to receive the filtered information and displays the information in a portal site format.

3. The system according to claim 1, wherein the processor is configured to receive input of the search keyword and transmitting the search keyword.
